(19) United States
(12) Patent Application Publication
(10) Pub. No.: US 2008/0082217 A1
(43) Pub. Date: Apr. 3, 2008

(54) Cooking apparatus with temperature display unit and method of controlling the same

(75) Inventors: Han Jun Sung, Yongin-si (KR); Dae Sung Han, Hwaseong-si (KR); Yong Hyun Kwon, Suwon-si (KR); Seok Weon Hong, Yongin-si (KR); Tae Uk Lee, Suwon-si (KR); Pung Yeun Cho, Suwon-si (KR); Han Seong Kang, Hwasung-si (KR); Sung Soo Park, Hwaseong-si (KR); Sung Kwang Kim, Ansan-si (KR); Tae Hun Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-si (KR)

(21) Appl. No.: 11/905,383

(22) Filed: Sep. 28, 2007

(30) Foreign Application Priority Data
Sep. 28, 2006 (KR) 2006-95153
Feb. 5, 2007 (KR) 2007-11856

(51) Int. Cl. G05D 23/19; G05D 23/00

(52) U.S. Cl. 700/299; 700/300

(57) ABSTRACT

Disclosed are a cooking apparatus and a method of controlling the same, which are capable of easily recognizing change in temperature of one of an oven and a cooktop through change in color corresponding to the temperature change at a position remote from the cooking apparatus, and which are capable of easily recognizing the temperature of the cooktop through a temperature display unit at a position that is somewhat lower than the cooktop by installing a temperature display unit at a position higher than the cooktop. To this end, the cooking apparatus includes a main body having at least one heating unit, a control panel installed on an upper surface of the main body, and a temperature display unit that is provided on the control panel, which displays a temperature of the heating unit through change in color.

### CROSS-REFERENCE TO RELATED APPLICATIONS

This application claims the benefit of Korean Patent Application Nos. 2006-95153 and 2007-11856, filed on Sep. 28, 2006, and Feb. 5, 2007, in the Korean Intellectual Property Office, the disclosure of which is incorporated herein by reference.

### BACKGROUND

1. Field

The present invention relates generally to a cooking apparatus and a method of controlling the same, and more particularly to an oven range having a combination of an oven and a cooktop, and a method of controlling the same.

2. Description of the Related Art

Such an oven range includes a main body having the shape of a cabinet, an oven in the main body, and a cooktop having at least one heating unit at an upper portion of the main body. Electricity or gas is used for an energy source to heat foodstuff.

In the case of the oven range, a control panel is installed at any one of the front (usually, the upside of an oven door) and the top of the main body. The control panel is a user interface having a plurality of buttons, keypads, etc., such that a user can set a desired cooking mode or various conditions required for the cooking. This control panel may include a display device that allows the user to check a cooking mode or condition(s) which are set at present, an ongoing cooking state, etc.

The oven range includes an oven, the front of which is provided with a door for selectively opening and closing the oven. The oven is mounted therein with a heater. The temperature in the oven is increased by heating the heater caused by the application of electric power or burning of gas, so that any foodstuff situated inside is heated. The control panel is provided with a display device, such as a 7-segment module or a liquid crystal display (LCD) panel, to display the temperature in the oven. Thus, when using the oven, the user recognizes a current temperature of the oven by viewing the temperature displayed on the display device in figures.

In order to allow the user to correctly recognize the temperature of the oven at a relatively remote distance in the system that displays the temperature of the oven in figures, the display device, such as the 7-segment module or the LCD panel, to display the figures should have sufficient dimensions. In particular, in order to check the temperature of the oven range in the middle of another work at a place remote from the oven range while cooking is proceeding in a cookroom by the oven range, the temperature display unit should have good visibility.

However, from the viewpoint of dimensional limit and high-grade design of the control panel, the existing display device is difficult to form in as sufficient a size as needed, so that the figure display unit displaying the temperature cannot help having a small size as well. This small-size display device makes it difficult to recognize the current temperature of the oven at a place remote from the oven range to a certain extent.

In the oven range, the cooktop has a structure in which a radiant heating unit is installed on the upper portion of the main body, and in which a shielding panel, such as a glass panel or a ceramic panel, is shielded above the radiant heating unit. When the radiant heating unit below the shielding panel is powered, the radiant heating unit emits heat. The heat is transferred to a container placed on the radiant heating unit through the shielding panel, so that the foodstuff in the container is heated.

When the supply of electric power is started, the radiant heating unit of the cooktop is very rapidly heated to reach a target temperature. In contrast, when the supply of electric power is stopped due to the termination of the use, the temperature of the radiant heating unit is lowered for a relatively long time. In the state where the temperature of the radiant heating unit is not sufficiently lowered, the user's attention is required.

The conventional cooktop is provided with a display unit to display a heated state of the radiant heating unit. This display unit functions to warn the user that the user's attention is required because the radiant heating unit of the cooktop is currently heated at a relatively high temperature, and thus the display unit calls the user's attention to the radiant heating unit until the temperature of the radiant heating unit of the cooktop is lowered below a safety temperature at which the user is allowed to be in contact with the radiant heating unit.

However, when the display unit to display a heated state of the radiant heating unit of the cooktop is installed on the upper surface of the cooktop, a person whose height is similar or less than the installation height of the cooktop (i.e. the height of the main body of the oven range) cannot look at the display unit, and thus has difficulty checking the heated state of the radiant heating unit.

### SUMMARY

Accordingly, the present embodiments have been made to solve the above-mentioned problems, and an aspect of the present embodiments is to provide a cooking apparatus and a method of controlling the same, capable of easily recognizing the change in temperature of a heating unit at a position remote from the cooking apparatus by displaying the temperature change through a change in color corresponding to the temperature change.

Another aspect of the present embodiments is to provide a cooking apparatus and a method of controlling the same, capable of recognizing a rough temperature of the cooking apparatus at a remote distance and a precise temperature of the cooking apparatus at a near distance, so that the drawback in that a size of the display unit must be larger than a predetermined size, providing easy recognition so that the conventional figure display mode can be complemented.

Another object of the present invention is to provide a cooking apparatus and a method of controlling the same, in which a temperature display unit is installed at a position higher than that of a heating unit, thereby allowing the position of the heating unit to be easily recognized through a temperature display unit at a position that is somewhat lower than the heating unit.

Additional aspects and/or advantages will be set forth in part in the description which follows and, in part, will be apparent from the description, or may be learned by practice of the embodiments.

The foregoing/and or other aspects are achieved by providing a cooking apparatus, which includes a main body having at least one heating unit, a control panel installed on an upper surface of the main body, and a temperature display unit provided on the control panel and displaying a temperature of the heating unit through a change in color of the temperature display unit.

Here, the temperature display unit may display a temperature section, to which a current temperature of the heating unit belongs, among a plurality of preset temperature sections through the color change.

Further, the preset temperature sections may each be divided into a fixed size within the maximum allowable heating temperature range of the heating unit.

Further, the preset temperature sections may each be varied within a target cooking temperature range set by a user according to the set target cooking temperature range.

Meanwhile, the temperature display unit may include a plurality of light emitting elements, and the temperature display unit is varied into a representative color of each of the preset temperature sections by turning on/off the plurality of light emitting elements.

Further, the temperature display unit may form a highlight by turning some of the light emitting elements on in a color different from colors of remaining light emitting elements, and may more precisely display the current temperature of the heating unit through a position of the highlight within the temperature section to which the current temperature of the heating unit belongs.

Further, the current temperature of the heating unit may be displayed within a temperature range in one of the preset temperature sections.

Further, the current temperature of the heating unit may be displayed in an entire temperature display range from a minimum temperature to a maximum allowable heating temperature of the heating unit.

Further, the current temperature of the heating unit may be displayed in an entire temperature display range from a minimum temperature of the heating unit to a target cooking temperature set by a user.

Also, the temperature display unit may include a plurality of light emitting elements, and display the current temperature of the heating unit by increasing or decreasing a length of a turned-on portion of the temperature display unit in response to change in the temperature of the heating unit.

Further, the temperature display unit may have a representative color of each temperature section in which the turned-on portion of the temperature display unit is preset.

Further, the current temperature of the heating unit may be displayed in an entire temperature display range from the minimum temperature to the maximum allowable heating temperature of the heating unit.

Further, the current temperature of the heating unit may be displayed in an entire temperature display range from the minimum temperature to a target cooking temperature of the heating unit.

Further, the temperature display unit may include a plurality of light emitting elements, and may display that the temperature of the heating unit reaches a target temperature by allowing a highlight, formed by turning on some of the light emitting elements when the temperature of the heating unit reaches the target temperature, to reciprocate in the temperature display unit.

Further, the temperature display unit may include a plurality of light emitting elements, and may display that the temperature of the heating unit reaches a target temperature by allowing the light emitting elements to be turned on and off in a representative color corresponding to the current temperature of the heating unit when the temperature of the heating unit reaches the target temperature.

Here, the temperature display unit may include a plurality of light emitting elements, and be installed such that the light emitting elements have a linear shape in a row.

Further, the temperature display unit may include a plurality of light emitting elements, and be installed such that the light emitting elements have a curved shape in a row.

Further, the temperature display unit may display a higher temperature of the heating unit among the temperatures of the heating units when all of the heating units are in operation.

Further, the heating unit may include the heating unit of a cooktop that is provided on an upper portion of the main body.

Further, the heating unit may include the heating unit of an oven provided in the main body.

The foregoing and/or other aspects are achieved by providing a method of controlling a cooking apparatus, in which the cooking apparatus includes a main body having at least one heating unit, a control panel installed on an upper surface of the main body, and a temperature display unit that is provided on the control panel, displaying a temperature of the heating unit through change in color, and having a plurality of light emitting elements. The method includes determining whether or not the heating unit is in operation, detecting a current temperature of the heating unit when the heating unit is in operation, and displaying a temperature section, to which the detected current temperature of the heating unit belongs, among a plurality of preset temperature sections through change in the color of the temperature display unit.

Here, the preset temperature sections may each be divided into a fixed size within a maximum allowable heating temperature range of the heating unit.

Further, the preset temperature sections may each be varied within a target cooking temperature range set by a user according to the set target cooking temperature range.

Further, the temperature of the heating unit may be displayed by displaying an entire temperature display unit in a representative color of each of the preset temperature sections by means of turning on/off of the plurality of light emitting elements according to change in temperature of the heating unit.

Meanwhile, the method may further include turning on some of the light emitting elements in a color different from the colors of remaining light emitting elements to thus form a highlight, and more precisely displaying the current temperature of the heating unit through a position of the highlight within the temperature section to which the current temperature of the heating unit belongs.

Here, the current temperature of the heating unit may be displayed in an entire temperature display range from a minimum temperature to a maximum allowable heating temperature of the heating unit.

Further, the current temperature of the heating unit may be displayed in an entire temperature display range from the minimum temperature of the heating unit to a target cooking temperature set by a user.

Further, the temperature display unit may display the current temperature of the heating unit by increasing or decreasing a length of a turned-on portion of the temperature display unit in response to change in the temperature of the heating unit.

Also, the current temperature of the heating unit may be displayed in an entire temperature display range from the minimum temperature to the maximum allowable heating temperature of the heating unit.

Further, the current temperature of the heating unit may be displayed in an entire temperature display range from the minimum temperature of the heating unit to a target cooking temperature set by a user.

Further, the temperature display unit may display that the temperature of the heating unit reaches a target temperature by allowing a highlight, formed by turning some of the light emitting elements on when the temperature of the heating unit reaches the target temperature, to reciprocate in the temperature display unit.

Further, the temperature display unit may display that the temperature of the heating unit reaches a target temperature by allowing the light emitting elements to be turned on and off in a representative color corresponding to the current temperature of the heating unit when the temperature of the heating unit reaches the target temperature.

The foregoing and/or other aspects are achieved by providing a method of controlling a cooking apparatus, in which the cooking apparatus includes a main body having at least one heating unit, a control panel installed on an upper surface of the main body, and a temperature display unit that is provided on the control panel, displaying a temperature of the heating unit through change in color, and having a plurality of light emitting elements. The method comprises determining whether or not the heating unit in operation stops operating, detecting a current temperature of the heating unit when determined that the heating unit stops operating, and displaying a temperature section, to which the detected current temperature of the heating unit belongs, among a plurality of preset temperature sections through the change in the color of the temperature display unit.

Here, the preset temperature sections may each be divided into a fixed size within a maximum allowable heating temperature range of the heating unit.

Further, the preset temperature sections may each be varied within a target cooking temperature range set by a user according to the set target cooking temperature range.

Further, the temperature of the heating unit may be displayed by displaying an entire temperature display unit in a representative color of each of the preset temperature sections by turning on/off the plurality of light emitting elements according to change in temperature of the heating unit.

Meanwhile, the method may further include turning on some of the light emitting elements in a color different from the colors of remaining light emitting elements to form a highlight, and displaying the current temperature of the heating unit through a position of the highlight within the temperature section to which the current temperature of the heating unit belongs.

Further, the current temperature of the heating unit may be displayed in an entire temperature display range from a minimum temperature to a maximum allowable heating temperature of the heating unit.

Further, the current temperature of the heating unit may be displayed in an entire temperature display range from the minimum temperature of the heating unit to a target cooking temperature set by a user.

Also, the temperature display unit may display the current temperature of the heating unit by increasing or decreasing a length of a turned-on portion of the temperature display unit in response to change in the temperature of the heating unit.

Further, the current temperature of the heating unit may be displayed in an entire temperature display range from the minimum temperature to the maximum allowable heating temperature of the heating unit.

Further, the current temperature of the heating unit may be displayed in an entire temperature display range from the minimum temperature of the heating unit to a target cooking temperature set by a user.

Further, the temperature display unit may display that the temperature of the heating unit reaches a target temperature by allowing a highlight, formed by turning on some of the light emitting elements when the temperature of the heating unit reaches the target temperature, to reciprocate in the temperature display unit.

In addition, the temperature display unit may display that the temperature of the heating unit reaches a target temperature by allowing the light emitting elements to be turned on and off in a representative color corresponding to the current temperature of the heating unit when the temperature of the heating unit reaches the target temperature.

The foregoing and/or other aspects are achieved by providing a method of controlling a cooking apparatus, in which the cooking apparatus includes a main body having at least one heating unit, a control panel installed on an upper surface of the main body, and a temperature display unit that is provided on the control panel, displaying a temperature of the at least one heating unit through a change in color. The method includes determining whether or not the at least one heating units is in operation, comparing set temperatures of at least two heating units when the at least one heating unit is in operation, detecting a temperature of one of the heating units having a highest preset target cooking temperature among the heating units, and displaying the detected current temperature of the heating unit having the highest target cooking temperature through the change in color of the temperature display unit.

Here, when only one of the heating units is in operation, the temperature of the heating unit that is in operation may be detected and displayed through the color change of the temperature display unit.

The foregoing and/or other aspects are achieved by providing a cooking apparatus including a main body having at least one heating unit; and a temperature display unit affixed to the main body displaying a relative temperature of the heating unit by a color transmitted through the temperature display unit.

A specific temperature of the heating unit may be displayed by a position of a highlight within the temperature display unit.

A specific temperature of the heating unit may be displayed by a relative length of the displayed color.

The relative temperature of the heating unit may be a temperature within a set range with respect to a maximum allowable heating temperature.

The relative temperature of the heating unit may be a temperature within a set range with respect to a target cooking temperature.

The temperature display unit includes a plurality of temperature sections, and the relative temperature of the heating unit is displayed within one of the temperature sections.

Each of the temperature sections may be divided into a fixed size based on a set range with respect to a maximum allowable heating temperature.

Each of the temperature sections may be divided into a fixed size based on a set range with respect to a target cooking temperature.

The highlight may reciprocate throughout the temperature display unit when a current temperature of the heating unit reaches at least one of a target temperature and a safe temperature.

The temperature display unit may be flickered when a current temperature of the heating unit reaches at least one of a target temperature and a safe temperature.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a perspective view of an electric oven range according to an embodiment of the present invention;

FIG. 2 illustrates a perspective view of a structure of a temperature display unit of the electric oven range of FIG. 1;

FIG. 3 illustrates a block diagram of a control system of the electric oven range of FIG. 1;

FIG. 4 illustrates a first embodiment where increasing temperatures of a heating unit are displayed through the temperature display unit of the electric oven range of FIG. 1;

FIG. 5A illustrates a second embodiment where increasing temperatures of a heating unit are displayed through the temperature display unit of the electric oven range of FIG. 1;

FIG. 5B illustrates a third embodiment where increasing temperatures of a heating unit are displayed through the temperature display unit of the electric oven range of FIG. 1;

FIG. 6A illustrates a fourth embodiment where increasing temperatures of a heating unit are displayed through the temperature display unit of the electric oven range of FIG. 1;

FIG. 6B illustrates a fifth embodiment where increasing temperatures of a heating unit are displayed through the temperature display unit of the electric oven range of FIG. 1;

FIG. 7A illustrates a sixth embodiment where increasing temperatures of a heating unit are displayed through the temperature display unit of the electric oven range of FIG. 1;

FIG. 7B illustrates a seventh embodiment where increasing temperatures of a heating unit are displayed through the temperature display unit of the electric oven range of FIG. 1;

FIG. 8A illustrates an eighth embodiment where increasing temperatures of a heating unit are displayed through the temperature display unit of the electric oven range of FIG. 1;

FIG. 8B illustrates a ninth embodiment where increasing temperatures of a heating unit are displayed through the temperature display unit of the electric oven range of FIG. 1;

FIG. 9 illustrates a first embodiment where decreasing temperatures of a heating unit are displayed through the temperature display unit of the electric oven range of FIG. 1;

FIG. 10A illustrates a second embodiment where decreasing temperatures of a heating unit are displayed through the temperature display unit of the electric oven range of FIG. 1;

FIG. 10B illustrates a third embodiment where decreasing temperatures of a heating unit are displayed through the temperature display unit of the electric oven range of FIG. 1;

FIG. 11A illustrates a fourth embodiment where decreasing temperatures of a heating unit are displayed through the temperature display unit of the electric oven range of FIG. 1;

FIG. 11B illustrates a fifth embodiment where decreasing temperatures of a heating unit are displayed through the temperature display unit of the electric oven range of FIG. 1;

FIG. 12A illustrates a sixth embodiment where decreasing temperatures of a heating unit are displayed through the temperature display unit of the electric oven range of FIG. 1;

FIG. 12B illustrates a seventh embodiment where decreasing temperatures of a heating unit are displayed through the temperature display unit of the electric oven range of FIG. 1;

FIG. 13A illustrates an eighth embodiment where decreasing temperatures of a heating unit are displayed through the temperature display unit of the electric oven range of FIG. 1;

FIG. 13B illustrates a ninth embodiment where decreasing temperatures of a heating unit are displayed through the temperature display unit of the electric oven range of FIG. 1;

FIG. 14A is a flowchart illustrating a method of controlling a cooking apparatus in accordance with an embodiment of the present invention;

FIG. 14B is a flowchart illustrating a method of controlling a cooking apparatus in accordance with an embodiment of the present invention;

FIG. 15 is a flowchart illustrating another method of controlling a cooking apparatus in accordance with an embodiment of the present invention;

FIGS. 16A and 16B illustrate effects according to a position where the electric oven range of FIG. 1 is installed;

FIG. 17 illustrates another embodiment of the control panel of the electric oven range of FIG. 1; and

FIG. 18 illustrates another embodiment of the control panel of the electric oven range of FIG. 1.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

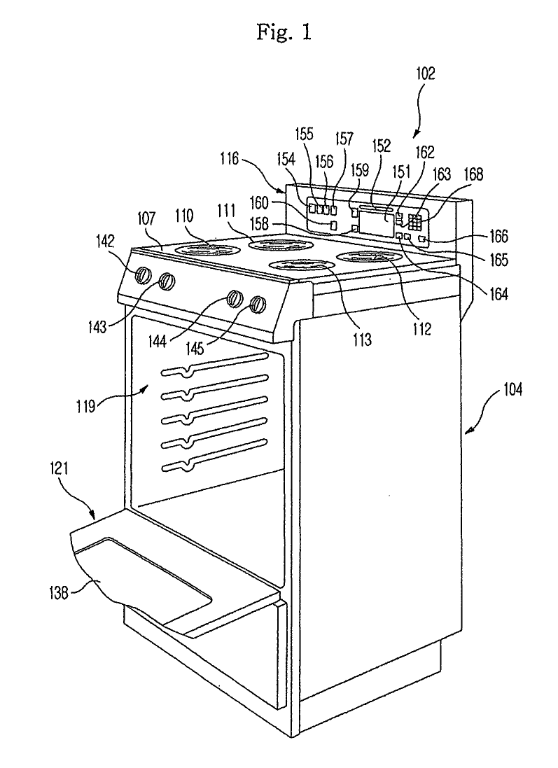

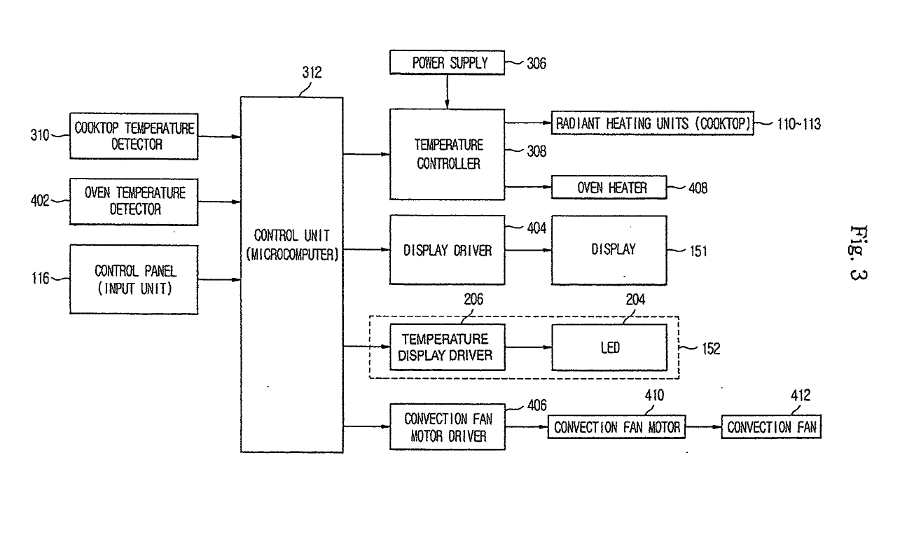

Hereinafter, embodiments of the present invention will be described with reference to FIGS. 1 through 18. FIG. 1 illustrates a perspective view of an electric oven range according to an embodiment of the present invention. As illustrated in FIG. 1, a cooking apparatus 102 such as an electric oven range includes a cabinet-shaped main body 104, which is provided with an oven 119 therein and a cooktop 107 at an upper portion thereof. The oven 119 is opened and closed by a door 121, which is provided with a transparent window 138. Thus, when the door is closed, a user can look into the oven 119 through the transparent window 138. For reference, the oven 119 is provided therein with an oven heater (first heating unit) (not shown) to heat internal air and an oven temperature detector (see FIG. 3) to detect temperature of the heated internal air. The cooktop 107 includes a plurality of radiant heating units 110 through 113 (second heating unit). The main body 104 is provided, at the front thereof, with a plurality of control knobs 142 through 145 that activate or inactivate the plurality of radiant heating units 110 through 113, respectively.

The electric oven range 102 is electrically controlled in response to manipulation by a user via a control panel 116. The control panel 116 is provided with various control buttons 154 through 157, which allow the user to select any one of a number of cooking modes, such as a baking mode (for breads and cookies), a roasting mode (for meats), a warming mode, etc. Further, the control panel 116 is provided with an operation mode cancel button 158, an illumination activation button 159, an auto-clean button 160, an operation setup button 162, a timer button 163, a cooking time button 164, a completion time button 165, a clock button 166, and a figure pad 168, for example.

Further, the control panel 116 of the electric oven range 102 includes a temperature display unit 152 together with a display 151. The display 151 displays the cooking mode and conditions which are set by the user, a percentage of current cooking completion, etc. The display 151 can be implemented as a 7-segment module or a liquid crystal display (LCD) panel. The temperature display unit 152 functions to display the temperatures of the oven 119 and the cooktop 107, and employs a light emitting device such as a high-brightness light emitting diode (LED), capable of variously varying a light-emitting color in order to increase visibility. Preferably, the temperature display unit 152 is installed on the relative upper side of the control panel 116. Thus, a user can view the temperature display unit 152 at a position that is lower than a height of the main body 104, i.e. a height at which the cooktop 107 is installed, by installing the temperature display unit 152 on the upper side of the control panel 116 that is installed to protrude from the top of the main body 104.

This temperature display unit 152 can include one or more units according to the construction of the cooking apparatus. In other words, if the cooking apparatus is provided with one of the oven and the cooktop, only one temperature display unit 152 can be installed. In contrast, if the cooking apparatus is provided with both of the oven and the cooktop, one temperature display unit 152 can be installed to display one of the temperatures of the oven and the cooktop, or two temperature display units 152 can be installed to display the respective temperatures of the oven and the cooktop, separately.

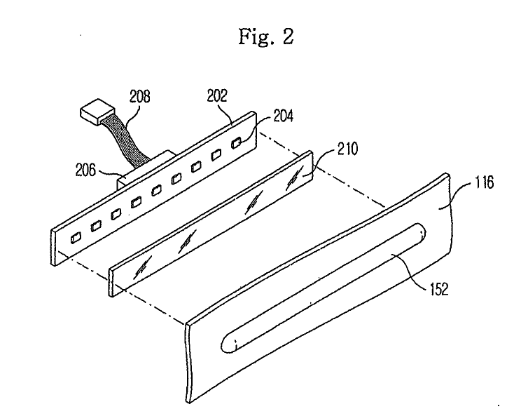

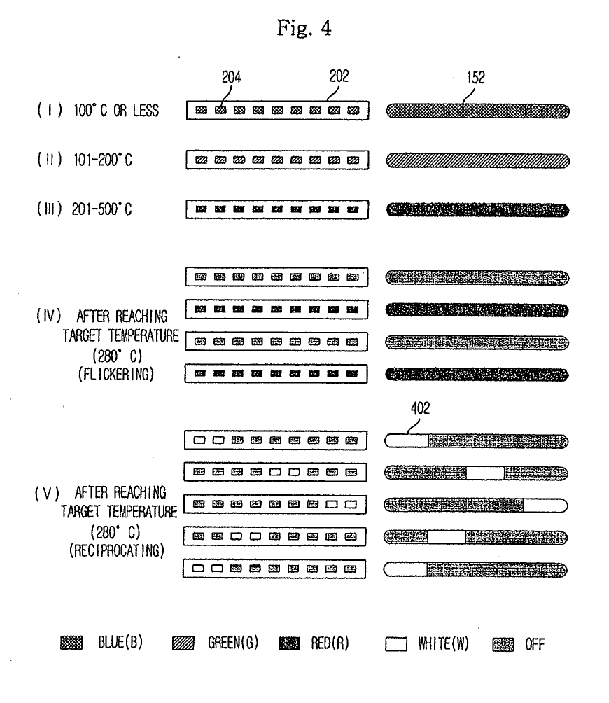

FIG. 2 illustrates a structure of the temperature display unit of the electric oven range of FIG. 1. As illustrated in FIG. 2, a plurality of high-brightness LEDs 204 that may vary in color are mounted in a row at regular intervals at the front of a narrow, long printed circuit board 202, and a temperature display driver 206, having a type of an integrated circuit (IC), that drives the plurality of LEDs 204 is mounted at the rear of the printed circuit board 202. Thereby, a circuit of the printed circuit board 202 is constructed such that the temperature display driver 206 electrically communicates with the plurality of LEDs 204. The temperature display driver 206 is connected to a control unit (see FIG. 4) controlling the overall operation of the electric oven range 102 through a communication cable 208, and controls on/off, light-emitting color, etc., of each LED 204 in response to a control signal from the control unit. Each LED 204 preferably employs an LED module, which can emit light in various colors including blue (B), green (G) and red (R).

The printed circuit board 202 is provided with a diffusion member 210 which broadly diffuses the light emitted from the LEDs 204 on one side thereof on which the LEDs 204 are mounted. The LEDs 204 are preferably mounted spaced apart from each other by a given distance, in consideration of the heat generation of each LED 204, the complexity of circuit configuration of the printed circuit board 202, etc. However, in this structure, when some or all of the LEDs 204 are turned on, the visibility thereof is somewhat lowered because the LEDs 204 that have been turned on serve as a plurality of individual light sources rather than one integrated light source due to the interval between the respective LEDs 204. Thus, the light emitted when some or all of the LEDs 204 are turned on is diffused by the diffusion member 210, so that the LEDs 204 which have been turned on act like one light source. This is preferable so that the visibility of the temperature display unit 152 can be increased.

The printed circuit board 202 and the diffusion member 210 are fixed to the rear of the control panel 116, by, for example, a fastening member, such as a bolt or an adhesive. In the control panel 116, a portion where the printed circuit board 202 and the diffusion member 210 are fixed is provided with a narrow long window 212. The light emitted from the LEDs 204 that are turned on is diffused by the diffusion member 210, and then is emitted at the control panel 116 through the window 212, allowing the user to visually recognize the light. If necessary, the diffusion member 210 may directly function as the window without separately installing the diffusion member 210 and the window 212.

FIG. 3 illustrates a block diagram of a control system of the electric oven range of FIG. 1. As illustrated in FIG. 3, a control unit (microcomputer) 312 is connected with a cooktop temperature detector 310, an oven temperature detector 402, and an input of the control panel 116 on an input side thereof. The input of the control panel 116 corresponds to input buttons, excluding the display 151 and the temperature display unit 152 from the control panel 116. The cooktop temperature detector 310 detects the temperature of the radiant heating unit 110 (strictly, the temperature of a radiant heating element of the radiant heating unit 110), and provides the detected value to the control unit 312.

The control unit 312 is connected with a temperature controller 308 connected to a power supply 306, a display driver 404, the temperature display unit 152, and a convection fan motor driver 406 on an output side thereof. The temperature controller 308 receives the temperature of the radiant heating unit 110 detected by the cooktop temperature detector 310, and intercepts power supplied to the radiant heating element, if necessary, such that the temperature of each of the radiant heating units 110 through 113 does not exceed a preset maximum allowable heating temperature (e.g., 56° C.) of the cooktop 107. In the case in which the cooktop 107 includes a plurality of the radiant heating units 110 through 113, as in the electric oven range 102 of FIG. 1, a cooktop temperature detector 310 is provided for each of the radiant heating units 110 through 113, and the temperatures detected by the respective cooktop temperature detectors 310 are provided to the control unit (microcomputer) 312 controlling the overall operation of the electric oven range 102. The oven heater 408 mentioned in the description of FIG. 1 is also supplied with the power via the temperature controller 308, and the temperature of the oven heater 408 is controlled by the temperature controller 308. A display 151 is driven by the display driver 404 and displays a cooking mode or cooking conditions, a percentage of current cooking completion, etc., which are set by the user. The convection fan motor driver 406 functions to drive a convection fan motor 410 to rotate a convection fan 412. The convection fan 412 provides air convection in the oven 119.

In FIG. 3, the control unit 312 generates a control signal to display any one of the temperatures detected by the cooktop temperature detector 310 and the oven temperature detector 402 through the temperature display unit 152, and provides the control signal to the temperature display driver 206. The temperature display driver 206 controls on/off, light-emitting color, etc., of each LED 204 in response to a control signal provided from the control unit 312, thereby allowing any one of the temperature of each of the radiant heating units 110 through 113 of the cooktop 107 and the temperature in the oven 119 to be displayed through the temperature display unit 152. In particular, when the temperature of each of the radiant heating units 110 through 113 of the cooktop 107 is displayed through the temperature display unit 152, the control unit 312 controls the temperature display driver 206 such that, if the number of the radiant heating units is two or more, the highest one of the temperatures of the radiant heating units is displayed as a representative temperature of the cooktop 107.

The expressions used in the present invention are defined as follows.

The “temperature of the heating unit” refers to the temperature of air in the oven 119 detected by the oven temperature detector 402 or the temperature of each of the radiant heating units 110 through 113 of the cooktop detected by the cooktop temperature detector 310.

The “change in the color of the temperature display unit” refers to the change in the color of the temperature display unit 152 caused by the light emitted from the respective light-emitting elements, i.e. the respective LEDs 204, constituting the temperature display unit 152, as well as the change in the color of the temperature display unit 152 caused by the turning-on/off of the respective LEDs 204.

The “representative color of the temperature display unit” refers to the predominant color of the temperature display unit 152 formed by the turning-on of a predominant number of the light-emitting elements among the light-emitting elements, i.e. the LEDs 204, constituting the temperature display unit 152. The relative concept of the “representative color” refers to a “highlight,” which is a small-scale color formed by the turning-on of the relatively fewer number of the LEDs 204. For example, if seven of the nine LEDs 204 are turned on in a blue (B) color, and the other LEDs are turned on in a red (R) color, the “representative color” is the blue (B) color, and the “highlight” is the “red (R) color.”

The “heating temperature range” refers to the temperature range from the temperature at which the oven 119 or the cooktop 107 is not heated to the maximum allowable heating temperature at which the oven 119 or the cooktop 107 can be heated. For example, when the maximum allowable heating temperature at which the oven 119 can be heated is 280° C., the oven heater 408 is adapted not to exceed a temperature of 280° C. by interception of the power supplied thereto. For reference, the temperature at which the oven 119 or the cooktop 107 is not heated at all cannot be limited to a specific temperature because the temperature at which the oven 119 or cooktop 107 is not heated can be varied depending on a surrounding temperature, but the temperature at which the oven 119 or cooktop 107 is not heated can be determined to have an upper limit, for example, “less than a predetermined temperature.” For example, when the heating temperature range of the oven 119 is divided into three temperature sections, the lowest temperature section may be set as a “section of 100° C. or less,” for example.

FIG. 4 illustrates a first embodiment increasing temperatures of a heating unit are displayed through the temperature display unit of the electric oven range of FIG. 1. In FIG. 4, the temperature up to a maximum allowable heating temperature is adopted as an entire temperature display section, and a temperature section to which a currently increasing temperature of the heating unit belongs is displayed through the change in the color of the temperature display unit 152. According to a display method of FIG. 4, a heating temperature range of the heating unit, particularly provided in the oven 119 or the cooktop 107, is divided into a plurality of temperature sections, and the current temperature of the heating unit is displayed by using one of the temperature sections based on the color change of the temperature display unit 152. The temperature sections are not divided into too many sections, but are divided, for instance, within a range from two to four, in order to increase visibility at a remote distance. Further, preferably, in order to increase the visibility to enable the user to intuitively recognize the temperature change of the heating unit, the temperature section belonging to a relatively lower temperature is displayed with a cold color-based color, for example, blue, whereas the temperature section belonging to a relatively higher temperature is displayed with a warm color-based color, for example, red.

As illustrated in FIG. 4, when the preset maximum allowable heating temperature of the heating unit (e.g. the oven 119) is 500° C., for example, the temperature sections are divided into three sections: 100° C. or less, 101° C. to 200° C., and 201° C. to 500° C. All of the LEDs 204 are turned on in a blue (B) color when the current temperature of the heating unit is less than 100° C., in a green (G) color when the current temperature is in the section from 101° C. to 200° C., and in a red (R) color when the current temperature is in the section from 201° C. to 500° C. Thereby, the temperature of the heating unit is displayed in different colors depending on the range into which the temperature falls. Thus, the user can easily check which one of the above-mentioned sections the current temperature of the heating unit belongs to only by checking the light-emitting color of the temperature display unit 152 at a position remote from the electric oven range 102.

When the temperature of the heating unit reaches a target temperature set by the user (e.g., 280° C.), the user is able to determine that the current temperature of the heating unit reaches the target temperature by the temperature display unit 152 being prompted to flicker the entire temperature display unit 152 in the red (R) color for a predetermined time as illustrated in FIG. 4 (IV). Further, the user is able to determine that the current temperature of the heating unit reaches the target temperature by the temperature display unit 152 being prompted to form a white highlight 402 to reciprocate left and right in the temperature display unit 152 for a predetermined time as illustrated in FIG. 4 (V).

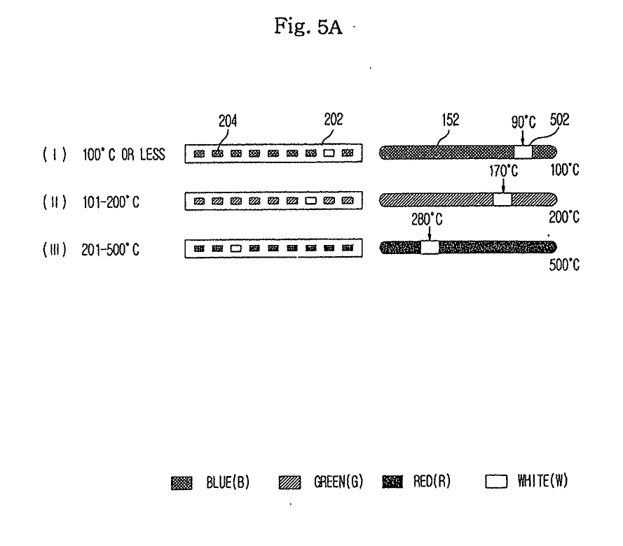

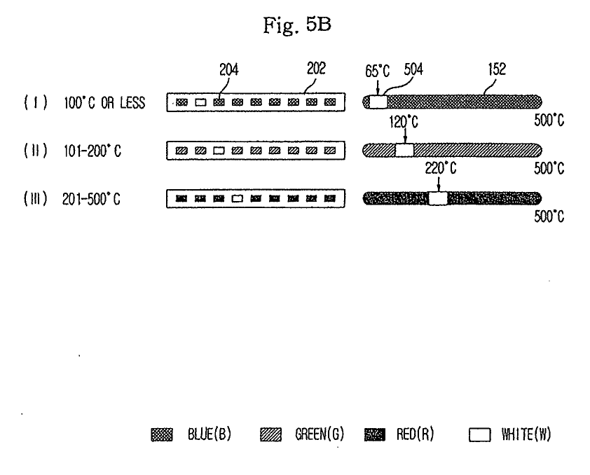

FIG. 5A illustrates a second embodiment where increasing temperatures of a heating unit are displayed through the temperature display unit of the electric oven range of FIG. 1. In FIG. 5A, the temperature up to the maximum allowable heating temperature is adopted as an entire temperature display section, and a temperature section to which a currently increasing temperature of the heating unit belongs is displayed through a change in the color of the temperature display unit 152 and is more precisely displayed through the change in the position of a highlight 502 within each temperature section. According to a display method of FIG. 5A, a heating temperature range (from the minimum temperature to the maximum allowable heating temperature) of the heating unit, particularly provided in the oven 119 or the cooktop 107, is divided into a plurality of temperature sections, and the current temperature of the heating unit is displayed by using one of the temperature sections based on the color change of the temperature display unit 152. However, in addition to this configuration, the temperature of the heating unit is more precisely displayed in each temperature section through the white (W) highlight 502. For example, when the current temperature of the heating unit (e.g. the oven 119) is 90° C., the temperature display unit 152 is turned on in the blue color, thereby displaying that the current temperature of the heating unit belongs to the section of 100° C. or less as in FIG. 5A (I) and simultaneously displaying that the more precise current temperature of the heating unit is 90° C. through an exact or an approximate position of the highlight 502. Thereby, the user can roughly know the temperature range of the heating unit through the color of the temperature display unit 152 at a remote distance, as well as more precisely know the current temperature of the heating unit through the position of the highlight 502 at a closer distance. When the temperature of the heating unit reaches a target temperature set by the user, the user is able to determine that the current temperature of the heating unit reaches the target temperature because the temperature display unit 152 is prompted to flicker or the highlight is reciprocated, as illustrated in FIGS. 4(IV) and 4(V).

FIG. 5B illustrates a third embodiment where increasing temperatures of a heating unit are displayed through the temperature display unit 152 of the electric oven range of FIG. 1. In FIG. 5B, the temperature up to the maximum allowable heating temperature is adopted as an entire temperature display section, and a temperature section to which a currently increasing temperature of the heating unit belongs is displayed through a change in the color of the temperature display unit 152, and is more precisely displayed through the change in the position of a highlight 504 within each temperature section. In the case of FIG. 5A, as described above, the current temperature of the heating unit is displayed through the relative position of the highlight 502 within the temperature section (e.g. from 101° C. to 200° C.) to which the current temperature of the heating unit belongs. In contrast, in the case of FIG. 5B, the current temperature of the heating unit is displayed through the relative position of the highlight 504 within an overall temperature section, i.e. a temperature range from the minimum temperature to the maximum allowable heating temperature (e.g., from the minimum temperature to 500° C.), of the heating unit. When the temperature of the heating unit reaches a target temperature set by the user, the user is able to determine that the current temperature of the heating unit reaches the target temperature because the temperature display unit 152 is prompted to flicker or the highlight is reciprocated as illustrated in FIGS. 4(IV) and 4(V).

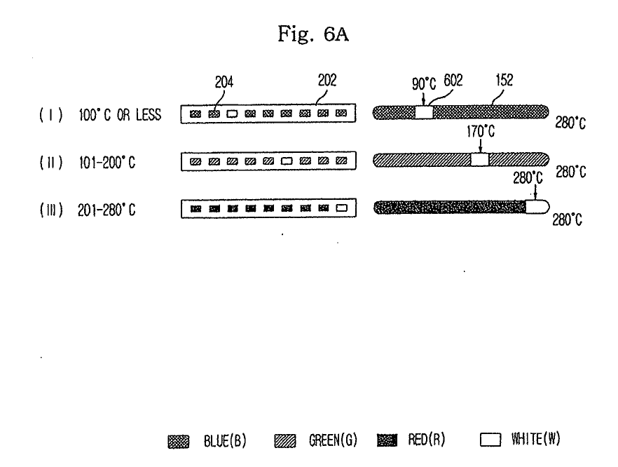

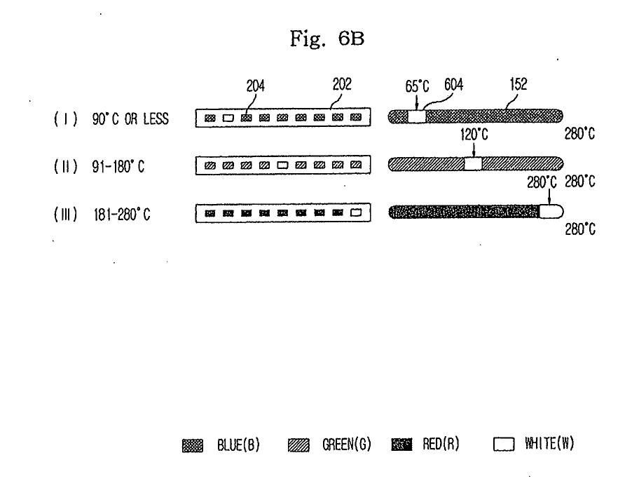

FIG. 6A illustrates a fourth embodiment where increasing temperatures of a heating unit are displayed through the temperature display unit of the electric oven range of FIG. 1. In FIG. 6A, the temperature up to a target cooking temperature set by the user is adopted as an entire temperature display section, and a temperature section to which a currently increasing temperature of the heating unit belongs is displayed through the change in the color of the temperature display unit 152, and is more precisely displayed through the change in the position of a highlight 602 within each temperature section. According to a display method of FIG. 6A, as illustrated in FIG. 4 generally, a heating temperature range (from the minimum temperature to a target cooking temperature set by the user) of the heating unit, particularly provided in the oven 119 or the cooktop 107, is divided into a plurality of temperature sections, and the current temperature of the heating unit is displayed by using one of the temperature sections based on the color change of the temperature display unit 152. However, in addition to this configuration, the temperature of the heating unit is more precisely displayed in each temperature section through a white (W) highlight 602. For example, when the current temperature of the heating unit (e.g., the oven 119) is 90° C., the temperature display unit 152 is turned on in a blue color, thereby displaying that the current temperature of the heating unit belongs to the section of 100° C. or less as in FIG. 6A(I), and simultaneously displaying that the more precise current temperature of the heating unit is 90° C. through the position of the highlight 602. Thereby, the user is able to roughly know the temperature range of the heating unit through the color of the temperature display unit 152 at a remote distance, as well as more precisely know the current temperature of the heating unit through the position of the highlight 602 at a near distance.

FIG. 6B illustrates a fifth embodiment where increasing temperatures of a heating unit are displayed through the temperature display unit of the electric oven range of FIG. 1. In FIG. 6B, the temperature up to a target cooking temperature set by the user is adopted as an entire temperature display section, and a temperature section to which a currently increasing temperature of the heating unit belongs is displayed through the change in the color of the temperature display unit 152, and is more precisely displayed through the change in the position of a highlight 604 within each temperature section. In the case of FIG. 6A as described above, the current temperature of the heating unit is displayed through the relative position of the highlight 602 within the temperature section (e.g. from 101° C. to 200° C.) to which the current temperature of the heating unit belongs. In contrast, in the case of FIG. 6B, the current temperature of the heating unit is displayed through the relative position of the highlight 604 within an overall temperature section, i.e., a temperature range from the minimum temperature to the target cooking temperature set by the user (e.g., from the minimum temperature to 280° C.), of the heating unit. When the temperature of the heating unit reaches a target temperature set by the user, the user is able to determine that the current temperature of the heating unit reaches the target temperature because the temperature display unit 152 is prompted to flicker or the highlight is reciprocated as illustrated in FIGS. 4(IV) and 4(V).

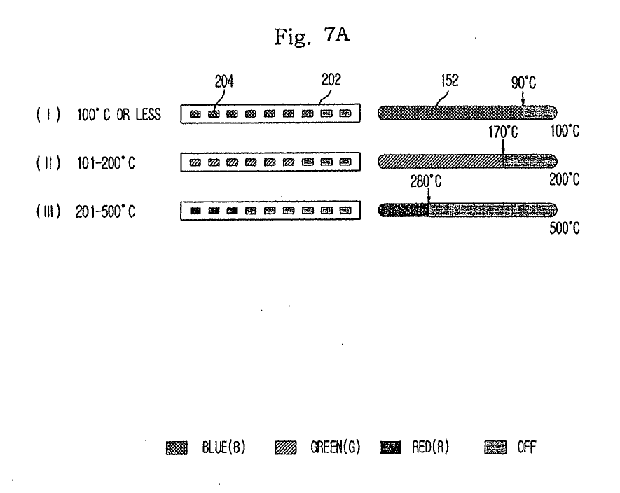

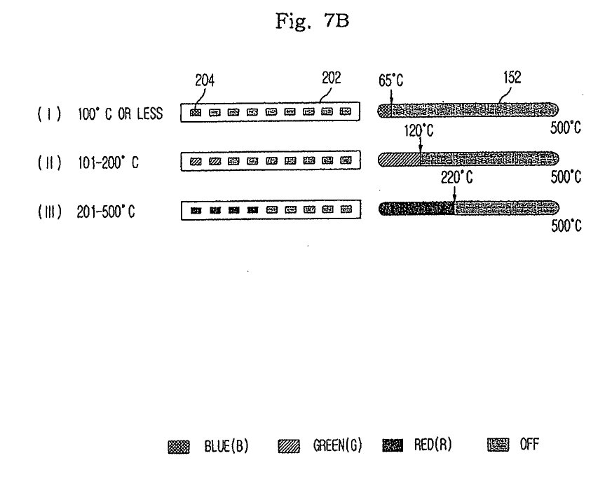

FIG. 7A illustrates a sixth embodiment where increasing temperatures of a heating unit are displayed through the temperature display unit of the electric oven range of FIG. 1. In FIG. 7A, the temperature up to the maximum allowable heating temperature is adopted as an entire temperature display section, and a temperature section to which a currently increasing temperature of the heating unit belongs is displayed through the change in the color of the temperature display unit, and is more precisely displayed through the change in the length of a turned-on portion of the temperature display unit within each temperature section. According to a display method of FIG. 7A, a heating temperature range of the heating unit, particularly provided in the oven 119 or the cooktop 107, is divided into a plurality of temperature sections, and the current temperature of the heating unit is displayed by using one of the temperature sections based on the change in the representative color of the temperature display unit 152. Simultaneously, the current temperature of the heating unit is more precisely displayed in the temperature section corresponding to the representative color by gradually increasing the number of LEDs 204 that are turned on among the LEDs 204 constituting the temperature display unit 152, and thus increasing the length of the representative color portion (i.e. the turned-on portion) of the temperature display unit 152 to be proportional to the current temperature of the heating unit. When the temperature of the heating unit reaches a target temperature set by the user, the user is able to determine that the current temperature of the heating unit reaches the target temperature because the temperature display unit 152 is prompted to flicker or the highlight is reciprocated as illustrated in FIGS. 4(IV) and 4(V).

FIG. 7B illustrates a seventh embodiment where increasing temperatures of a heating unit are displayed through the temperature display unit of the electric oven range of FIG. 1. In FIG. 7B, the temperature up to the maximum allowable heating temperature is adopted as an entire temperature display section, and a temperature section to which a currently increasing temperature of the heating unit belongs is displayed through the change in the color of the temperature display unit, and is more precisely displayed through the change in the length of a turned-on portion of the temperature display unit within each temperature section. In the case of FIG. 7A as described above, the current temperature of the heating unit is displayed through the relative length of the representative color portion within the temperature section (e.g., from 101° C. to 200° C.) to which the current temperature of the heating unit belongs. In contrast, in the case of FIG. 7B, the current temperature of the heating unit is displayed through the relative length of the representative color portion within an overall temperature section, i.e., a temperature range from the minimum temperature to the maximum allowable heating temperature (e.g., from the minimum temperature to 500° C.), of the heating unit. When the temperature of the heating unit reaches a target temperature set by the user, the user is able to determine that the current temperature of the heating unit reaches the target temperature because the temperature display unit 152 is prompted to flicker or the highlight is reciprocated as illustrated in FIGS. 4(IV) and 4(V).

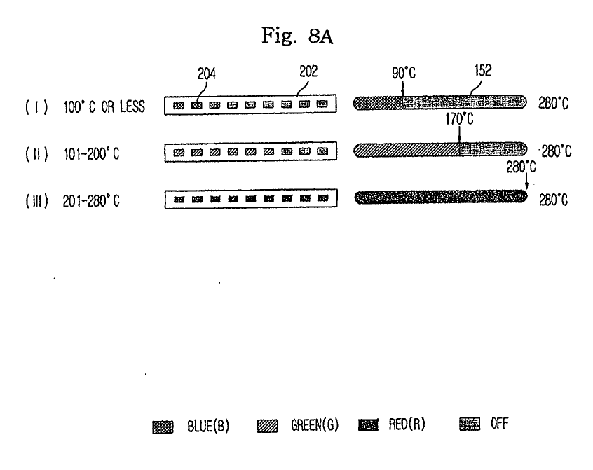

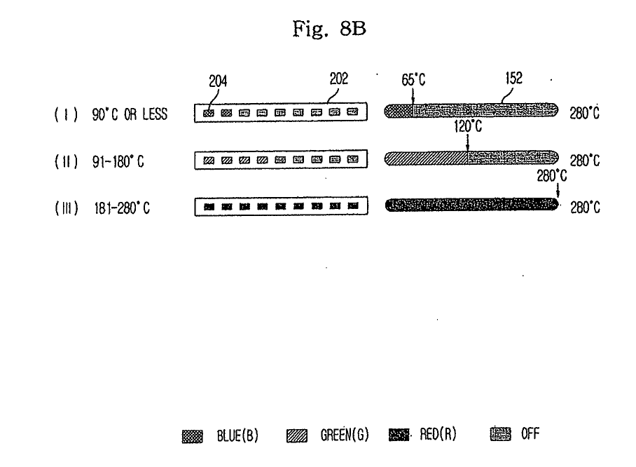

FIG. 8A illustrates an eighth embodiment where increasing temperatures of a heating unit are displayed through the temperature display unit of the electric oven range of FIG. 1. In FIG. 8A, the temperature up to a target cooking temperature set by the user is adopted as an entire temperature display section, and a temperature section to which a currently increasing temperature of the heating unit belongs is displayed through the change in the color of the temperature display unit, and is more precisely displayed through the change in the length of a turned-on portion of the temperature display unit within each temperature section. According to a display method of FIG. 8A, a heating temperature range of the heating unit, particularly provided in the oven 119 or the cooktop 107, is divided into a plurality of temperature sections, and the current temperature of the heating unit is displayed by using one of the temperature sections based on the change in the representative color of the temperature display unit 152. Simultaneously, the current temperature of the heating unit is more precisely displayed in the temperature section corresponding to the representative color by gradually increasing the number of LEDs 204 that are turned on among the LEDs 204 constituting the temperature display unit 152, and thus increasing the length of the representative color portion (i.e., the turned-on portion) of the temperature display unit 152 to be proportional to the current temperature of the heating unit. When the temperature of the heating unit reaches a target temperature set by the user, the user is able to determine that the current temperature of the heating unit reaches the target temperature because the temperature display unit 152 is prompted to flicker or the highlight is reciprocated as illustrated in FIGS. 4(IV) and 4(V).

FIG. 8B illustrates a ninth embodiment where increasing temperatures of a heating unit are displayed through the temperature display unit of the electric oven range of FIG. 1. In FIG. 8B, the temperature up to the maximum allowable heating temperature is adopted as an entire temperature display section, and a temperature section to which a currently increasing temperature of the heating unit belongs is displayed through the change in the color of the temperature display unit, and is more precisely displayed through the change in the length of a turned-on portion of the temperature display unit within each temperature section. In the case of FIG. 8A as described above, the current temperature of the heating unit is displayed through the relative length of the representative color portion within the temperature section (e.g., from 101° C. to 200° C.) to which the current temperature of the heating unit belongs. In contrast, in the case of FIG. 8B, the current temperature of the heating unit is displayed through the relative length of the representative color portion within an overall temperature section, i.e., a temperature range from the minimum temperature to the maximum allowable heating temperature (e.g., from the minimum temperature to 280° C.), of the heating unit. When the temperature of the heating unit reaches a target temperature set by the user, the user is able to determine that the current temperature of the heating unit reaches the target temperature because the temperature display unit 152 is prompted to flicker or the highlight is reciprocated as illustrated in FIGS. 4(IV) and 4(V).

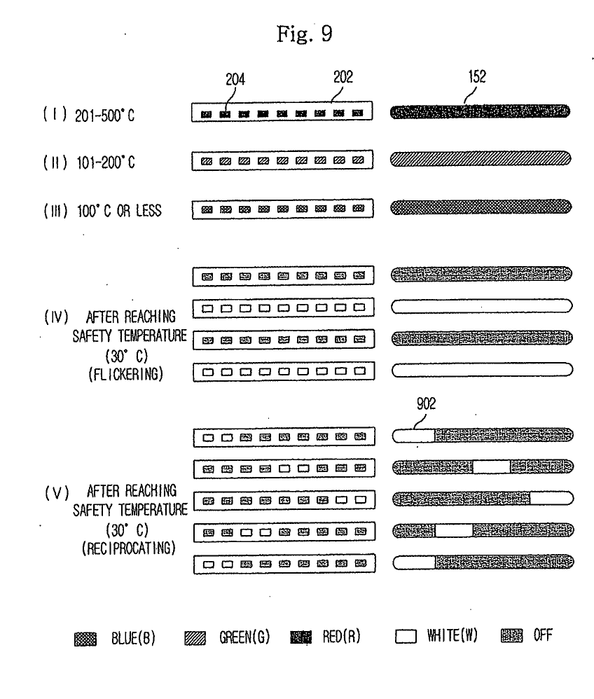

FIG. 9 illustrates a first embodiment where decreasing temperatures of a heating unit are displayed through the temperature display unit of the electric oven range of FIG. 1. In FIG. 4, the temperature from the maximum allowable heating temperature to the minimum temperature is adopted as an entire temperature display section, and a temperature section to which a currently decreasing temperature of the heating unit belongs is displayed through the change in the color of the temperature display unit.

As illustrated in FIG. 9, when the preset maximum allowable heating temperature of the heating unit (e.g., the oven 119) is 500° C., the temperature sections are divided into three sections: from 201° C. to 500° C., from 101° C. to 200° C., and 100° C. or less. All of the LEDs 204 are turned on in a red (R) color when the current temperature of the heating unit is in the section from 201° C. to 500° C., in a green (G) color when the current temperature is in the section from 101° C. to 200° C., and in a blue (B) color when the current temperature is less than 100° C. Thereby, the temperature of the heating unit is displayed in different colors. Thus, the user can easily check which one of the above-mentioned sections the current temperature of the heating unit belongs to only by checking the light-emitting color of the temperature display unit 152 at a position remote from the electric oven range 102.

When the decreasing temperature of the heating unit reaches a safe temperature (e.g., 30° C.) set by the user, the user is able to determine that the current temperature of the heating unit reaches the safe temperature as the entire temperature display unit 152 is flickered in a white (W) color for a predetermined time as illustrated in FIG. 9(IV). Further, the user is able to determine that the current temperature of the heating unit reaches the safe temperature as a white highlight 902 is formed and is reciprocated left and right in the temperature display unit 152 for a predetermined time as illustrated in FIG. 9(V).

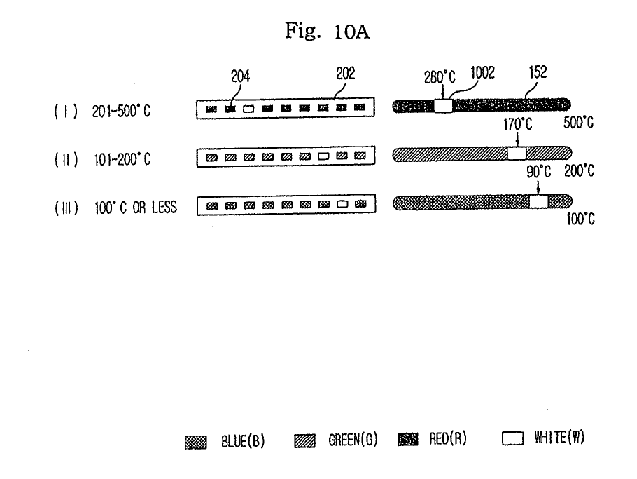

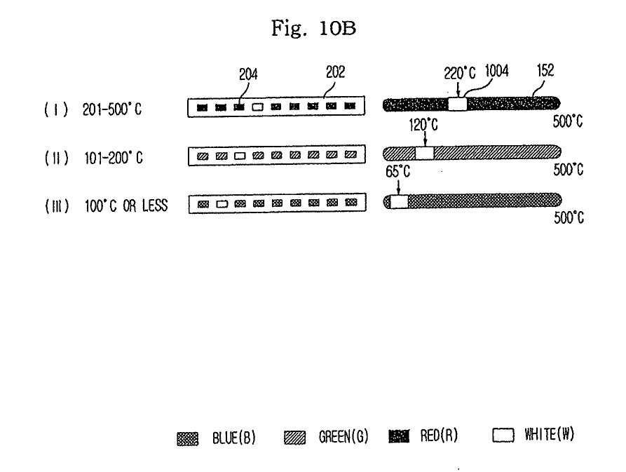

FIG. 10A illustrates a second embodiment where decreasing temperatures of a heating unit are displayed through the temperature display unit of the electric oven range of FIG. 1. In FIG. 5A, the temperature from the maximum allowable heating temperature to the minimum temperature is adopted as an entire temperature display section, and a temperature section to which a currently decreasing temperature of the heating unit belongs is displayed through the change in the color of the temperature display unit 152, and is more precisely displayed through the change in the position of a highlight within each temperature section. According to a display method of FIG. 10A, as illustrated in FIG. 9 generally, a heating temperature range (from the minimum temperature to the maximum allowable heating temperature) of the heating unit, particularly provided in the oven 119 or the cooktop 107, is divided into a plurality of temperature sections, and the current temperature of the heating unit is displayed by using one of the temperature sections based on the color change of the temperature display unit 152. However, in addition to this configuration, the temperature of the heating unit is more precisely displayed in each temperature section through the white (W) highlight 1002.

For example, when the current temperature of the heating unit (e.g., the oven 119) is 90° C., the temperature display unit 152 is turned on in a blue color, thereby displaying that the current temperature of the heating unit belongs to the section of 100° C. or less, as in FIG. 10A(I), and simultaneously displaying that the more precise current temperature of the heating unit is 90° C. through the position of the highlight 1002. Thereby, the user can roughly know the temperature range of the heating unit through the color of the temperature display unit 152 at a remote distance, as well as more precisely know the current temperature of the heating unit through the position of the highlight 1002 at a near distance. When the temperature of the heating unit reaches a safe temperature, the user is able to determine that the current temperature of the heating unit reaches the safe temperature as the temperature display unit 152 is flickered or the highlight is reciprocated, as illustrated in FIGS. 9(IV) and 9(V).

FIG. 10B illustrates a third embodiment where decreasing temperatures of a heating unit are displayed through the temperature display unit of the electric oven range of FIG. 1. In FIG. 10B, the temperature from the maximum allowable heating temperature to the minimum temperature is adopted as an entire temperature display section, and a temperature section to which a currently decreasing temperature of the heating unit belongs is displayed through the change in the color of the temperature display unit, and is more precisely displayed through the change in the position of a highlight within each temperature section. In the case of FIG. 10A as described above, the current temperature of the heating unit is displayed through the relative position of the highlight 1002 within the temperature section (e.g., from 101° C. to 200° C.) to which the current temperature of the heating unit belongs. In contrast, in the case of FIG. 10B, the current temperature of the heating unit is displayed through the relative position of the highlight 1004 within an overall temperature section, i.e., a temperature range from the maximum allowable heating temperature to the minimum temperature (e.g., from 500° C. to the minimum temperature), of the heating unit. When the temperature of the heating unit reaches a safe temperature, the user is able to determine that the current temperature of the heating unit reaches the safe temperature because the temperature display unit 152 is flickered or the reciprocating as illustrated in FIGS. 9(IV) and 9(V).

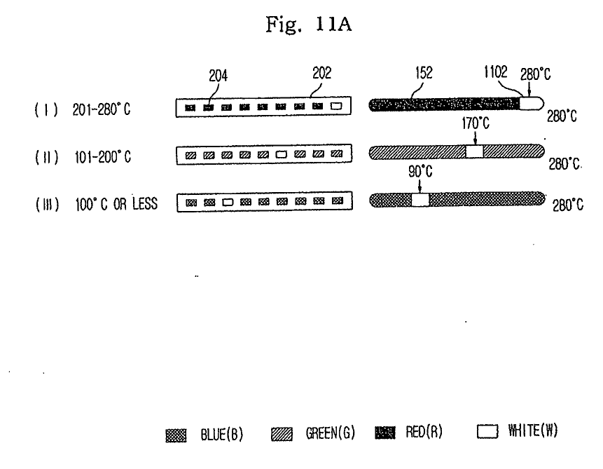

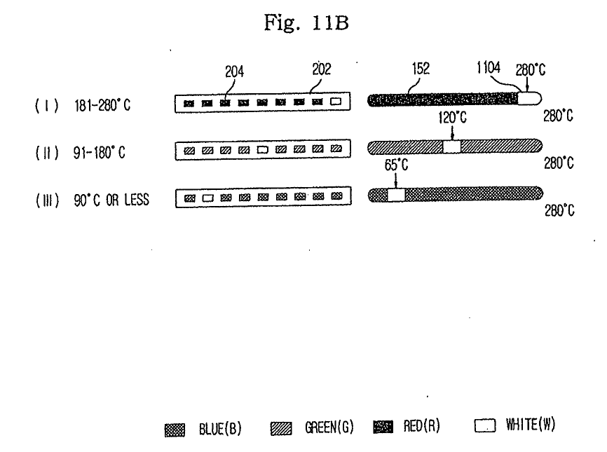

FIG. 11A illustrates a fourth embodiment where decreasing temperatures of a heating unit are displayed through the temperature display unit of the electric oven range of FIG. 1. In FIG. 11A, the temperature from a target cooking temperature set by the user to the minimum temperature is adopted as an entire temperature display section, and a temperature section to which a currently decreasing temperature of the heating unit belongs is displayed through the change in the color of the temperature display unit, and is more precisely displayed through the change in the position of a highlight within each temperature section. According to a display method of FIG. 11A, as illustrated in FIG. 9 generally, a heating temperature range (from a target cooking temperature set by the user to the minimum temperature) of the heating unit, particularly provided in the oven 119 or the cooktop 107, is divided into a plurality of temperature sections, and the currently decreasing temperature of the heating unit is displayed by using one of the temperature sections based on the color change of the temperature display unit 152. However, in addition to this configuration, the temperature of the heating unit is more precisely displayed in each temperature section through the white (W) highlight 1102. For example, when the current temperature of the heating unit (e.g., the oven 119) is 90° C., the temperature display unit 152 is turned on in a blue color, thereby displaying that the current temperature of the heating unit belongs to the section of 100° C. or less, as in FIG. 11A(III), and simultaneously displaying that the more precise current temperature of the heating unit is 90° C. through the position of the highlight 1102. Thereby, the user can roughly know the temperature range of the heating unit through the color of the temperature display unit 152 at a remote distance, as well as more precisely know the current temperature of the heating unit through the position of the highlight 1102 at a near distance.

FIG. 11B illustrates a fifth embodiment where decreasing temperatures of a heating unit are displayed through the temperature display unit of the electric oven range of FIG. 1. In FIG. 11B, the temperature from the maximum allowable heating temperature to the minimum temperature is adopted as an entire temperature display section, and a temperature section to which a currently decreasing temperature of the heating unit belongs is displayed through the change in the color of the temperature display unit, and is more precisely displayed through the change in the position of a highlight within each temperature section. In the case of FIG. 11A as described above, the current temperature of the heating unit is displayed through the relative position of the highlight 1102 within the temperature section (e.g., from 101° C. to 200° C.) to which the current temperature of the heating unit belongs. In contrast, in the case of FIG. 11B, the currently decreasing temperature of the heating unit is displayed through the relative position of the highlight 1104 within an overall temperature section, i.e., a temperature range from the minimum temperature to the target cooking temperature set by the user (e.g., from the minimum temperature to 280° C.), of the heating unit. When the temperature of the heating unit reaches a safe temperature, the user is able to determine that the current temperature of the heating unit reaches the safe temperature as the temperature display unit 152 is prompted to flicker or the highlight is reciprocated as illustrated in FIGS. 9(IV) and 9(V).

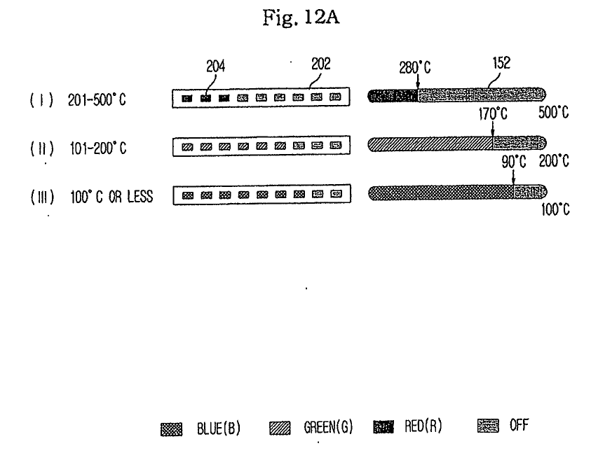

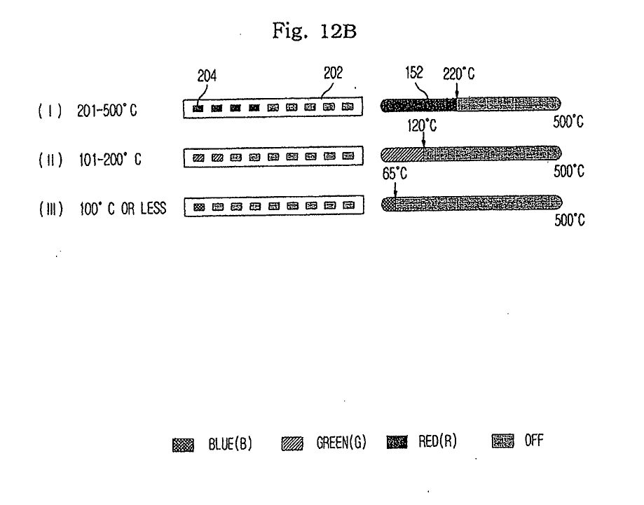

FIG. 12A illustrates a sixth embodiment where decreasing temperatures of a heating unit are displayed through the temperature display unit of the electric oven range of FIG. 1. In FIG. 12A, the temperature from the maximum allowable heating temperature to the minimum temperature is adopted as an entire temperature display section, and a temperature section to which a currently decreasing temperature of the heating unit belongs is displayed through the change in the color of the temperature display unit, and is more precisely displayed through the change in the length of a turned-on portion of the temperature display unit within each temperature section. According to a display method of FIG. 12A, a heating temperature range of the heating unit, particularly provided in the oven 119 or the cooktop 107, is divided into a plurality of temperature sections, and the currently decreasing temperature of the heating unit is displayed by using one of the temperature sections based on the change in the representative color of the temperature display unit 152. Simultaneously, the currently decreasing temperature of the heating unit is more precisely displayed in the temperature section corresponding to the representative color by gradually decreasing the number of LEDs 204 that are turned on among the LEDs 204 constituting the temperature display unit 152, and thus decreasing the length of the representative color portion (i.e., the turned-on portion) of the temperature display unit 152 to be proportional to the current temperature of the heating unit. When the temperature of the heating unit reaches a safe temperature, the user is able to determine that the current temperature of the heating unit reaches the safe temperature as the temperature display unit 152 is prompted to flicker or the highlight is reciprocated as illustrated in FIGS. 9(IV) and 9(V).

FIG. 12B illustrates a seventh embodiment where decreasing temperatures of a heating unit are displayed through the temperature display unit of the electric oven range of FIG. 1. In FIG. 12B, the temperature from the maximum allowable heating temperature to the minimum temperature is adopted as an entire temperature display section, and a temperature section to which a currently decreasing temperature of the heating unit belongs is displayed through the change in the color of the temperature display unit, and is more precisely displayed through the change in the length of a turned-on portion of the temperature display unit within each temperature section. In the case of FIG. 12A as described above, the currently decreasing temperature of the heating unit is displayed through the relative length of the representative color portion within the temperature section (e.g., from 101° C. to 200° C.) to which the current temperature of the heating unit belongs. In contrast, in the case of FIG. 12B, the current temperature of the heating unit is displayed through the relative length of the representative color portion within an overall temperature section, i.e., a temperature range from the maximum allowable heating temperature to the minimum temperature (e.g., from 500° C. to the minimum temperature), of the heating unit. When the temperature of the heating unit reaches a safe temperature, the user is able to determine that the current temperature of the heating unit reaches the safe temperature as the temperature display unit 152 is flickered or a highlight is reciprocated as illustrated in FIGS. 9(IV) and 9(V).

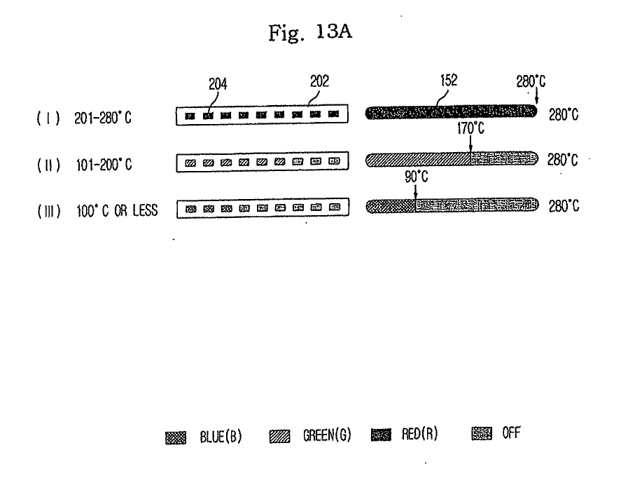

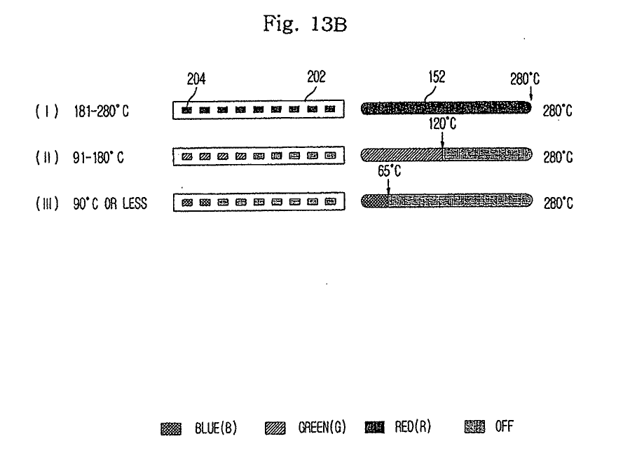

FIG. 13A illustrates an eighth embodiment where decreasing temperatures of a heating unit are displayed through the temperature display unit of the electric oven range of FIG. 1. In FIG. 13A, the temperature from a target cooking temperature set by the user to the minimum temperature is adopted as an entire temperature display section, and a temperature section to which a currently decreasing temperature of the heating unit belongs is displayed through the change in the color of the temperature display unit, and is more precisely displayed through the change in the length of a turned-on portion of the temperature display unit within each temperature section. According to a display method of FIG. 13A, a heating temperature range of the heating unit, particularly provided in the oven 119 or the cooktop 107, is divided into a plurality of temperature sections, and the currently decreasing temperature of the heating unit is displayed by using one of the temperature sections based on the change in the representative color of the temperature display unit 152. Simultaneously, the currently decreasing temperature of the heating unit is more precisely displayed in the temperature section corresponding to the representative color by gradually decreasing the number of LEDs 204 that are turned on among the LEDs 204 constituting the temperature display unit 152, and thus decreasing the length of the representative color portion (i.e., the turned-on portion) of the temperature display unit 152 to be proportional to the current temperature of the heating unit. When the temperature of the heating unit reaches a safe temperature, the user is able to determine that the current temperature of the heating unit reaches the safe temperature as the temperature display unit 152 is flickered or a highlight is reciprocated as illustrated in FIGS. 9(IV) and 9(V).

FIG. 13B illustrates a ninth embodiment where decreasing temperatures of a heating unit are displayed through the temperature display unit of the electric oven range of FIG. 1. In FIG. 13B, the temperature from the maximum allowable heating temperature to the minimum temperature is adopted as an entire temperature display section, and a temperature section to which a currently decreasing temperature of the heating unit belongs is displayed through the change in the color of the temperature display unit, and is more precisely displayed through the change in the length of a turned-on portion of the temperature display unit within each temperature section. In the case of FIG. 13A as described above, the currently decreasing temperature of the heating unit is displayed through the relative length of the representative color portion within the temperature section (e.g., from 101° C. to 200° C.) to which the current temperature of the heating unit belongs. In contrast, in the case of FIG. 8B, the currently decreasing temperature of the heating unit is displayed through the relative length of the representative color portion within an overall temperature section, i.e., a temperature range from the maximum allowable heating temperature to the minimum temperature (e.g., from 280° C. to the minimum temperature), of the heating unit. When the temperature of the heating unit reaches a safe temperature, the user is able to determine that the current temperature of the heating unit reaches the safe temperature as the temperature display unit 152 is flickered or a highlight is reciprocated as illustrated in FIGS. 9(IV) and 9(V).

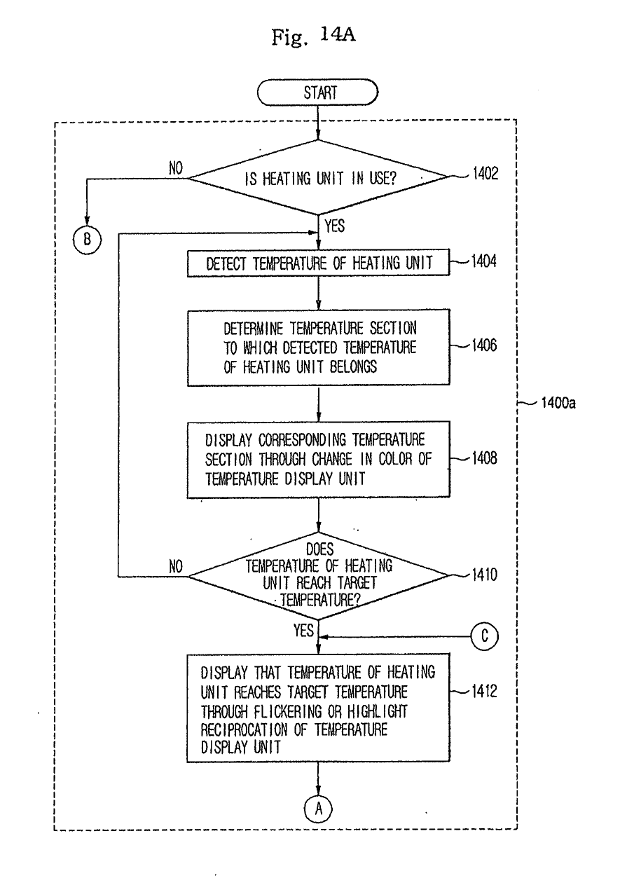

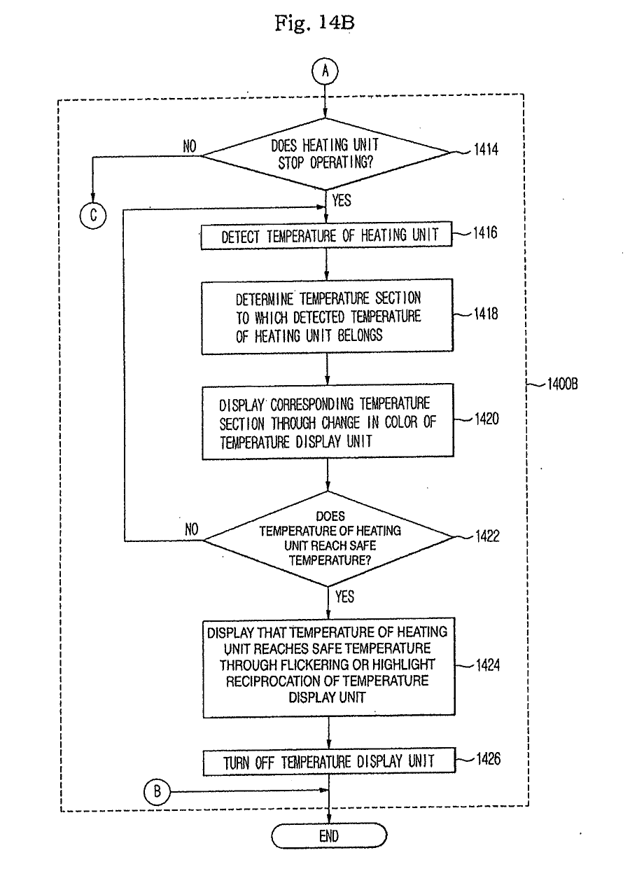

FIGS. 14A and 14B are flowcharts illustrating a method of controlling a cooking apparatus in accordance with an embodiment of the present invention. First, according to the flowchart 1400a, as illustrated in FIG. 14A, it is checked whether or not the heating unit provided to the cooking apparatus is in use (operation 1402). If the heating unit is in use (YES in operation 1402), a temperature of the heating unit is detected (operation 1404). If the heating unit is not in use, the operation ends. Further, it is determined whether or not the currently detected temperature of the heating unit belongs to any one of a plurality of preset temperature sections (operation 1406). When the temperature section to which the currently detected temperature of the heating unit belongs is determined, the determined temperature section is displayed through the change in the color of the temperature display unit 152 (operation 1408). When the heating unit is continuously heated to reach a target temperature (YES in operation 1410), it is displayed that the temperature of the heating unit reaches the target temperature as the temperature display unit 152 is flickered or a highlight is reciprocated (operation 1412). Here, the target temperature refers to a high temperature for cooking foodstuff.

Subsequently, according to a flowchart 1400b, as illustrated in FIG. 14B, it is checked whether or not the heating unit in operation stops operating (operation 1414). If the heating unit is continuously operated (NO in operation 1414), it proceeds to operation 1412 of FIG. 14A. If the heating unit stops operating (YES in operation 1414), a temperature of the heating unit is detected (operation 1416). At this time, the detected temperature of the heating unit refers to a decreasing temperature of the heating unit that stops operating. It is determined whether or not the currently detected temperature of the heating unit belongs to any one of the plurality of preset temperature sections (operation 1418). When the temperature section to which the currently detected temperature of the heating unit belongs is determined, the determined temperature section is displayed through the change in the color of the temperature display unit 152 (operation 1420). When the heating unit is continuously heated to reach a target safe temperature (YES in operation 1422), it is displayed that the temperature of the heating unit reaches the target temperature as the temperature display unit 152 is flickered or the highlight is reciprocated (operation 1424). Here, the target safe temperature refers to a safe temperature (low temperature) for safety of the user. When the flickering of the temperature display unit 152 or the highlight reciprocation is carried out for a predetermined time, the temperature display unit 152 is turned off (operation 1426).

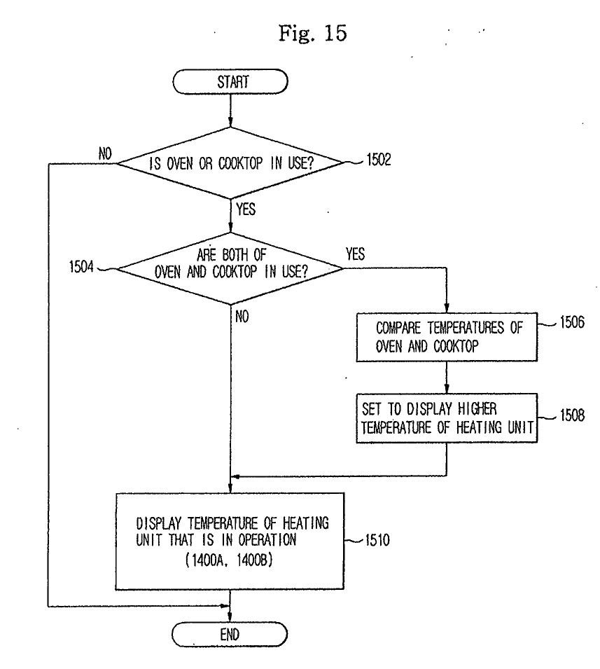

FIG. 15 is a flowchart illustrating another method of controlling a cooking apparatus in accordance with an embodiment of the present invention. According to the control method of FIG. 15, the electric oven range 102 includes a plurality of heating units, particularly provided in the oven 119 and the cooktop 107, and a temperature of any one of the heating units is displayed through one temperature display unit 152. As illustrated in FIG. 15, it is checked whether or not any one of the heating units, particularly provided in the oven 119 and the cooktop 107, is in use (operation 1502). If any one of the oven 119 and the cooktop 107 are not in use, the operation ends. If any one of the oven 119 and the cooktop 107 is in use (YES in operation 1502), it is checked whether both of the oven 119 and the cooktop 107 are in use (operation 1504). If both of the oven 119 and the cooktop 107 are in use (YES in operation 1504), current temperatures of the oven 119 and the cooktop 107 that are in use are detected and compared with each other (operation 1506). As a result, a higher temperature of the current temperatures of the oven 119 and the cooktop 107 is set to be displayed (operation 1508).

When it is checked that only one of the oven 119 and the cooktop 107 is in use (NO in operation 1504), and when the higher temperature of the current temperatures of the oven 119 and the cooktop 107, both of which are in use, is set to be displayed, a temperature of the corresponding heating unit in operation is displayed through the temperature display unit 152 as the next control operation (operation 1510). Here, the temperature of the corresponding heating unit in operation is displayed using the control method of FIGS. 14A and 14B as described above.

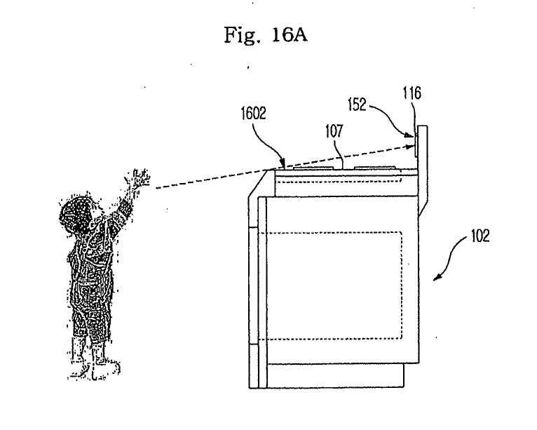

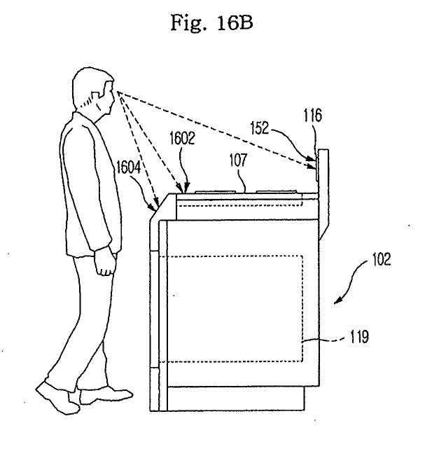

FIGS. 16A and 16B illustrate effects according to a position where the electric oven range of FIG. 1 is installed. According to an embodiment of the present invention, the temperature display unit 152 is installed in the electric oven range 102 at a position as high as possible, so that the temperature display unit 152 can be more easily seen at a position that is somewhat lower than a height of the cooktop 107.

As illustrated in FIG. 16A, because the display unit to display the heated state of the cooktop 107 in the conventional electric oven range is installed on the upper surface 1602 of the cooktop 107, a person whose height is similar or less than the height of the cooktop 107 cannot look at the display unit 152 of the cooktop 107, and thus fails to check the heated state of the cooktop 107. In contrast, because the temperature display unit 152 according to an embodiment of the present invention is installed on the highest side of the control panel 116 that is installed to protrude above the cooktop 107, the installation position of the temperature display unit 152 corresponds to the highest position in the electric oven range 102. Thus, a small person such as a child can easily check the internal temperature of the oven 119 and the temperature of the cooktop 107 through the temperature display unit 152.

Further, as in the embodiment of the present invention, when the temperature display unit 152 is installed at the highest position in the electric oven range 102, a tall person such as an adult can more easily look at the temperature display unit 152 with the person's head raised to some extent, unlike the conventional electric oven range where the person must bow the person's head in order to look at the conventional display unit installed on the upper surface 1602 of the cooktop 107. For this reason, the internal temperature of the oven 119 and the temperature of the cooktop 107 can be more conveniently checked. In other words, when the internal temperature of the oven 119 or the temperature of the cooktop 107 is checked during the cooking using the cooktop 107 in the state where the user approaches the electric oven range 102 as in FIG. 16B, the user can conveniently check the temperature through the temperature display unit 152, according to the embodiment of the present invention, which is installed at a relatively higher position than the conventional display unit that is installed on the upper surface 1602 or at the front 1604 of the cooktop 107 of the electric oven range 102.

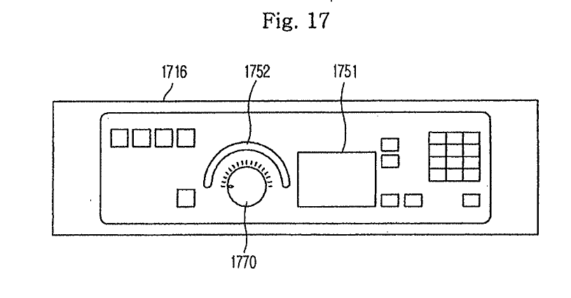

FIG. 17 illustrates another embodiment of the control panel of the electric oven range of FIG. 1. As illustrated in FIG. 17, when a cylindrical knob 1770 is installed on the control panel 1716, a curved temperature display unit 1752 is provided around the cylindrical knob 1770. Thereby, an area which the control panel 1716 occupies can be reduced compared to a linear temperature display unit. Particularly, this curved temperature display unit 1752 can preferably prevent the control panel 1716 from being increased due to a long linear temperature display unit when a display 1751 is not provided or has a very small size.

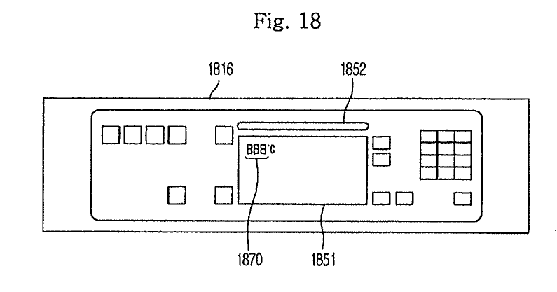

FIG. 18 illustrates another embodiment of the control panel 1816 of the electric oven range of FIG. 1. As illustrated in FIG. 18, in the case of the electric oven range having a display 1851 capable of displaying the temperature of the oven 119 or the cooktop 107 in figures, the display 1851 that displays the temperature in figures is also limited in size due to the restriction on the size thereof. In this case, according to the embodiment of the present invention, a temperature display unit 1852 employs a high-brightness light emitting element to display the temperature of the oven 119 or the cooktop 107 in colors. Thereby, the temperature of the oven 119 or the cooktop 107 is roughly recognized through the color of the temperature display unit 1852 at a remote distance, and is more precisely recognized at a near distance because it is displayed on the display 1851 in figures. Thus, the convenience of the user is promoted with regard to the recognition of the temperature of the oven 119 or the cooktop 107 through mutual complementation between the display 1851 and the temperature display unit 1852.

Further, as illustrated in FIG. 18, in the case of providing the display 1851 capable of displaying the temperature of the oven 119 or the cooktop 107 in FIG. 1870 in addition to the temperature display unit 152, the display 1851 can be used as a device to display the temperature of the cooktop 107. In other words, the temperature of the cooktop 107 is displayed on the display 1851 in figures, so that the user can more precisely recognize a decreasing state of the temperature of the cooktop 107.

This temperature display unit according to the embodiment of the present invention can be applied to the electric oven range as well as the gas oven range.

The positional change of the highlight in the temperature display unit can be used to display a remaining time that it takes the temperature of the cooktop to reach a safe temperature, instead of the temperature of the cooktop.

In the temperature display unit, the colors of each LED and the highlight, which are representative of each temperature, and the number of LEDs that are turned on for the highlight may also be variously changed. The color expression and the flickering pattern of each LED, the change in the highlight, etc. are combined through these various changes, so that more various methods of displaying the temperature can be obtained.

As can be seen from the foregoing, according to the present invention, the temperatures of the oven and the cooktop can be easily recognized at a position remote from the cooking apparatus through the color change corresponding to the temperature change of any one of the oven and the cooktop.

In particular, the temperature of the cooking apparatus can be roughly recognized at a remote distance and precisely recognized at a near distance.

Further, since the temperature display unit is installed at a position higher than that of the cooktop, any child whose height is lower than the position of the cooktop can easily recognize a heated state of the cooktop through the temperature display unit according to the present invention, so that the child can use the cooking apparatus with safety.

Although a few embodiments have been described for illustrative purposes, those skilled in the art will appreciate that various modifications, additions and substitutions are possible, without departing from the scope and spirit of the invention as disclosed in the accompanying claims.

What is claimed is:

1. A cooking apparatus, comprising:
a main body having at least one heating unit;
a control panel installed on the main body; and
a temperature display unit provided on the control panel, and displaying a temperature of the heating unit through a change in color of the temperature display unit.

2. The cooking apparatus according to claim 1, wherein the temperature display unit displays a temperature section, to which a current temperature of the heating unit belongs, among a plurality of preset temperature sections through the color change.

3. The cooking apparatus according to claim 2, wherein the preset temperature sections are each divided into a fixed size within the maximum allowable heating temperature range of the heating unit.

4. The cooking apparatus according to claim 2, wherein the preset temperature sections are each varied within a target cooking temperature range set by a user according to the set target cooking temperature range.

5. The cooking apparatus according to claim 2, wherein the temperature display unit includes a plurality of light emitting elements, and the temperature display unit is varied into a representative color of each of the preset temperature sections by turning on/off the plurality of light emitting elements.

6. The cooking apparatus according to claim 5, wherein the temperature display unit forms a highlight by turning some of the light emitting elements on in a color different from colors of remaining light emitting elements, and wherein the current temperature of the heating unit is displayed by a position of the highlight within the temperature section.

7. The cooking apparatus according to claim 6, wherein the current temperature of the heating unit is displayed within a temperature range in one of the preset temperature sections.

8. The cooking apparatus according to claim 6, wherein the current temperature of the heating unit is displayed in an entire temperature display range from a minimum temperature to a maximum allowable heating temperature of the heating unit.

9. The cooking apparatus according to claim 5, wherein the current temperature of the heating unit is displayed in an entire temperature display range from a minimum temperature of the heating unit to a target cooking temperature set by a user.

10. The cooking apparatus according to claim 2, wherein the temperature display unit includes a plurality of light emitting elements, and displays the current temperature of the heating unit by increasing or decreasing a length of a turned-on portion of the temperature display unit in response to a change in the temperature of the heating unit.

11. The cooking apparatus according to claim 10, wherein the temperature display unit has a representative color according to each temperature section in which the turned-on portion of the temperature display unit is preset.

12. The cooking apparatus according to claim 10, wherein the current temperature of the heating unit is displayed in an entire temperature display range from a minimum temperature to a maximum allowable heating temperature of the heating unit.

13. The cooking apparatus according to claim 10, wherein the current temperature of the heating unit is displayed in an entire temperature display range from a minimum temperature to a target cooking temperature of the heating unit.

14. The cooking apparatus according to claim 2, wherein the temperature display unit includes a plurality of light emitting elements, and displays that the temperature of the heating unit reaches a target temperature by allowing a highlight, formed by turning some of the light emitting elements on when the temperature of the heating unit reaches the target temperature, to reciprocate in the temperature display unit.

15. The cooking apparatus according to claim 2, wherein the temperature display unit includes a plurality of light emitting elements, and displays that the temperature of the heating unit reaches a target temperature by allowing the light emitting elements to be turned on and off in a representative color corresponding to the current temperature of the heating unit when the temperature of the heating unit reaches the target temperature.

16. The cooking apparatus according to claim 1, wherein the temperature display unit includes a plurality of light emitting elements, and is installed such that the light emitting elements have a linear shape in a row.

17. The cooking apparatus according to claim 1, wherein the temperature display unit includes a plurality of light emitting elements, and is installed such that the light emitting elements have a curved shape in a row.

18. The cooking apparatus according to claim 1, wherein the temperature display unit displays a higher temperature of the heating unit among the temperatures of the heating units when all of the heating units are in use.

19. The cooking apparatus according to claim 1, wherein the heating unit includes the heating unit of a cooktop provided on an upper portion of the main body.

20. The cooking apparatus according to claim 1, wherein the heating unit includes the heating unit of an oven provided in the main body.

21. A method of controlling a cooking apparatus, in which the cooking apparatus includes a main body having at least one heating unit, a control panel installed on the main body, and a temperature display unit that is provided on the control panel, displaying a temperature of the heating unit through change in color, and having a plurality of light emitting elements, the method comprising:
determining whether or not the heating unit is in operation;
detecting a current temperature of the heating unit when the heating unit is in operation; and
displaying a temperature section, to which the detected current temperature of the heating unit belongs, among a plurality of preset temperature sections through the change in the color of the temperature display unit.

22. The method according to claim 21, wherein the preset temperature sections are each divided into a fixed size within a maximum allowable heating temperature range of the heating unit.

23. The method according to claim 21, wherein the preset temperature sections are each varied within a target cooking temperature range set by a user according to the set target cooking temperature range.

24. The method according to claim 21, wherein the temperature of the heating unit is displayed by displaying an entire temperature display unit in a representative color of each of the preset temperature sections by means of turning on/off of the plurality of light emitting elements according to change in temperature of the heating unit.

25. The method according to claim 24, further comprising turning on some of the light emitting elements in a color different from the colors of remaining light emitting elements to thus form a highlight, and more precisely displaying the current temperature of the heating unit through a position of the highlight within the temperature section to which the current temperature of the heating unit belongs.

26. The method according to claim 24, wherein the current temperature of the heating unit is displayed in an entire temperature display range from a minimum temperature to a maximum allowable heating temperature of the heating unit.

27. The method according to claim 24, wherein the current temperature of the heating unit is displayed in an entire temperature display range from a minimum temperature of the heating unit to a target cooking temperature set by a user.

28. The method according to claim 21, wherein the temperature display unit displays the current temperature of the heating unit by increasing or decreasing a length of a turned-on portion of the temperature display unit in response to change in the temperature of the heating unit.

29. The method according to claim 28, wherein the current temperature of the heating unit is displayed in an entire temperature display range from a minimum temperature to a maximum allowable heating temperature of the heating unit.

30. The method according to claim 28, wherein the current temperature of the heating unit is displayed in an entire temperature display range from a minimum temperature of the heating unit to a target cooking temperature set by a user.

31. The method according to claim 21, wherein the temperature display unit displays that the temperature of the heating unit reaches a target temperature by allowing a highlight, formed by turning some of the light emitting elements on when the temperature of the heating unit reaches the target temperature, to reciprocate in the temperature display unit.

32. The method according to claim 21, wherein the temperature display unit displays that the temperature of the heating unit reaches a target temperature by allowing the light emitting elements to be turned on and off in a representative color corresponding to the current temperature of the heating unit when the temperature of the heating unit reaches the target temperature.

33. A method of controlling a cooking apparatus, in which the cooking apparatus includes a main body having at least one heating unit, a control panel installed on the main body, and a temperature display unit that is provided on the control panel, displaying a temperature of the heating unit through change in color, and having a plurality of light emitting elements, the method comprising:
determining whether or not the heating unit in operation stops operating;
detecting a current temperature of the heating unit when determined that the heating unit stops operating; and
displaying a temperature section, to which the detected current temperature of the heating unit belongs, among a plurality of preset temperature sections through the change in the color of the temperature display unit.

34. The method according to claim 33, wherein the preset temperature sections are each divided into a fixed size within a maximum allowable heating temperature range of the heating unit.

35. The method according to claim 33, wherein the preset temperature sections are each varied within a target cooking temperature range set by a user according to the set target cooking temperature range.

36. The method according to claim 33, wherein the temperature of the heating unit is displayed by displaying an entire temperature display unit in a representative color of each of the preset temperature sections by turning on/off the plurality of light emitting elements according to change in temperature of the heating unit.

37. The method according to claim 36, further comprising turning on some of the light emitting elements in a color different from the colors of remaining light emitting elements to form a highlight, and displaying the current temperature of the heating unit through a position of the highlight within the temperature section to which the current temperature of the heating unit belongs.

38. The method according to claim 36, wherein the current temperature of the heating unit is displayed in an entire temperature display range from a minimum temperature to a maximum allowable heating temperature of the heating unit.

39. The method according to claim 36, wherein the current temperature of the heating unit is displayed in an entire temperature display range from a minimum temperature of the heating unit to a target cooking temperature set by a user.

40. The method according to claim 33, wherein the temperature display unit displays the current temperature of the heating unit by increasing or decreasing a length of a turned-on portion of the temperature display unit in response to change in the temperature of the heating unit.

41. The method according to claim 40, wherein the current temperature of the heating unit is displayed in an entire temperature display range from a minimum temperature to a maximum allowable heating temperature of the heating unit.

42. The method according to claim 40, wherein the current temperature of the heating unit is displayed in an entire temperature display range from a minimum temperature of the heating unit to a target cooking temperature set by a user.

43. The method according to claim 33, wherein the temperature display unit displays that the temperature of the heating unit reaches a safety temperature by allowing a highlight, formed by turning on some of the light emitting elements when the temperature of the heating unit reaches the safety temperature, to reciprocate in the temperature display unit.

44. The method according to claim 33, wherein the temperature display unit displays that the temperature of the heating unit reaches a safety temperature by allowing the light emitting elements to be turned on and off in a representative color corresponding to the current temperature of the heating unit when the temperature of the heating unit reaches the safety temperature.

45. A method of controlling a cooking apparatus, in which the cooking apparatus includes a main body having at least one heating unit, a control panel installed on the main body, and a temperature display unit that is provided on the control panel, displaying a temperature of the heating unit through a change in color, the method comprising:
determining whether or not the at least one heating unit is in operation;
comparing set temperatures of at least two heating units when the at least one heating unit is in operation;
detecting a temperature of one of the heating units having a highest preset target cooking temperature among the heating units; and
displaying the detected current temperature of the heating unit having the highest target cooking temperature through the change in color of the temperature display unit.

46. The method according to claim 45, wherein, when only one of the heating units is in operation, the temperature of the heating unit that is in operation is detected and is displayed through the color change of the temperature display unit.

47. A cooking apparatus, comprising:
a main body having at least one heating unit; and
a temperature display unit affixed to the main body displaying a relative temperature of the heating unit by a color transmitted through the temperature display unit.

48. The cooking apparatus according to claim 47, wherein a specific temperature of the heating unit is displayed by a position of a highlight within the temperature display unit.

49. The cooking apparatus according to claim 47, wherein a specific temperature of the heating unit is displayed by a relative length of the displayed color.

50. The cooking apparatus according to claim 47, where the relative temperature of the heating unit is a temperature within a set range with respect to a maximum allowable heating temperature.

51. The cooking apparatus according to claim 47, wherein the relative temperature of the heating unit is a temperature within a set range with respect to a target cooking temperature.

52. The cooking apparatus according to claim 47, wherein the temperature display units includes a plurality of temperature sections, and the relative temperature of the heating unit is displayed within one of the temperature sections.

53. The cooking apparatus according to claim 52, wherein each of the temperature sections are divided into a fixed size based on a set range with respect to a maximum allowable heating temperature.

54. The cooking apparatus according to claim 52, wherein each of the temperature sections are divided into a variable size based on a set range with respect to a target cooking temperature.

55. The cooking apparatus according to claim 48, wherein the highlight reciprocates throughout the temperature display unit when a current temperature of the heating unit reaches at least one of a target temperature and a safe temperature.

56. The cooking apparatus according to claim 47, wherein the temperature display unit is flickered when a current temperature of the heating unit reaches at least one of a target temperature and a safe temperature.
